(19) United States
(12) Patent Application Publication
(10) Pub. No.: US 2008/0088992 A1
(43) Pub. Date: Apr. 17, 2008

(54) GROUND FAULT CIRCUIT INTERRUPT DEVICE

(75) Inventor: Warren L. Williamson, Mesa, AZ (US)

Correspondence Address: ROGITZ & ASSOCIATES, 750 B STREET, SUITE 3120, SAN DIEGO, CA, 92101, US

(73) Assignee: JP Nolan & Company

(21) Appl. No.: 11/939,731

(22) Filed: Nov. 14, 2007

Related U.S. Application Data
(63) Continuation-in-part of application No. 11/273,138, filed on Nov. 14, 2005.

(51) Int. Cl. H02H 3/00

(52) U.S. Cl. 361/42

(57) ABSTRACT

A GFCI circuit for a 120/240 volt application employs a microcontroller to trip the circuit when voltage is too high or too low, in addition to tripping the circuit on a ground fault as indicated by a ground fault logic component. The microcontroller also permanently prevents circuit operation if an EOL condition is sensed, such as the failure of the power relay to trip during test or failure of the ground fault logic component to signal a ground fault during test.

This is a continuation in part of U.S. patent application Ser. No. 11/273,138, filed Nov. 14, 2005.

### I. FIELD OF THE INVENTION

The present invention relates generally to ground fault circuit interrupt (GFCI) devices, and more particularly to GFCI devices that retain functionality in 120/240 volt applications under broken neutral and reversed line/neutral conditions and that protect against end of life conditions.

### II. BACKGROUND OF THE INVENTION

Ground fault circuit interrupter (GFCI) devices are used to open the circuit between a power supply and a load when a ground fault condition is detected. In the most basic application, a GFCI device receives a “hot” line, usually 120 volts, and a neutral line as input, with the GFCI device including a pair of terminals, typically embodied in a socket, to which an electrical load such as an electrical tool can be connected.

In certain fields, such as the construction industry, multiple loads, e.g., power saws, power dills, jackhammers, and are welders, may require power, and it is convenient to power these tools using a single junction box, colloquially referred to as a “spider box”. A spider box typically has a single neutral input and two or more 120 volt “live” inputs, such that as between two “live” inputs, a 240 volt differential exists.

This arrangement presents challenges in terms of ground fault interruption, however, because two possibilities arise that can compromise the operation of a GFCI device. The first is a broken neutral input, which can happen as a spider box is moved around a construction site. The second possibility is that when a technician connects the inputs, he might unintentionally reverse the neutral line with one of the “live” power lines. The result is that depending on whether the loads are balanced (and usually they are not), either insufficient voltage may be present to operate the GFCI circuit, or the circuit and load can be exposed to excessively high voltage, which can damage them.

U.S. Pat. No. 6,021,034 teaches away from using a separate GFCI device for each “live” power line based on the contention that nuisance tripping can occur, and instead proposes to solve the problems noted above by providing an arrangement whereby power circuits must be operated in pairs. This is less than satisfactory.

Additionally, as understood herein it is desirable to provide an end of life indication for a GFCI.

### SUMMARY OF THE INVENTION

A GFCI device has a ground fault logic component outputting a signal representative of whether a ground fault exists, and a microcontroller connected to the ground fault logic component and opening a circuit between the power line and a load when a ground fault exists, when a wiring fault exists, and when an end of life (EOL) condition exists.

In another aspect, a GFCI device includes a current transformer engaged with at least one power line and a neutral line and a ground fault logic component communicating with the current transformer for generating a signal to cause a circuit between an electrical load and a power supply connected to the power line to open based on a ground fault signal input from the transformer. A microcontroller communicates with the ground fault logic component. The microcontroller causes the circuit between the power supply and electrical load to open when at least one voltage in the device exceeds a maximum voltage threshold due to the neutral line being broken or due to a power line being connected to a neutral line terminal and vice-versa. In addition or alternatively the microcontroller also causes the circuit between the power supply and electrical load to open when at least one voltage in the device falls below a minimum voltage threshold due to a neutral line being broken. In accordance with present principles, the microcontroller further causes the circuit between the power supply and electrical load to open when an end of life (EOL) condition is detected.

The EOL condition can be failure of a relay in the circuit to open in response to a test signal. It can also be failure of the ground fault logic component to indicate a ground fault in response to a test signal, e.g., within a predetermined period. If an EOL condition exists, the GFCI preferably cannot subsequently be reset to energize a load. The existence of an EOL condition can be stored in non-volatile memory of the microcontroller, and the EOL condition can be detected during a test that is automatically initiated by the microcontroller.

In yet another aspect, a 120/240 volt junction box has a first 120 volt line connected to a first GFCI device for powering at least a first load except under ground fault conditions, in which case the first GFCI device opens a circuit between the first 120 volt line and the first load, and a second 120 volt line connected to a second GFCI device for powering at least a second load except under ground fault conditions, in which case the second GFCI device opens a circuit between the second 120 volt line and the second load A neutral line is connected to both devices. First means in the first GFCI device prevent malfunctioning of the first GFCI device in the presence of a ground fault if the neutral line is broken and also prevent malfunctioning of the first GFCI device in the presence of a ground fault if the neutral line is reversed with one of the 120 volt lines. Likewise, second means in the second GFCI device prevent malfunctioning of the second GFCI device in the presence of a ground fault if the neutral line is broken and also prevent malfunctioning of the second GFCI device in the presence of a ground fault if the neutral line is reversed with one of the 120 volt lines. Third means in the first GFCI device prevent operation of the first GFCI device in the presence of an end of life (EOL) condition, while fourth means in the second GFCI device prevent operation of the second GFCI device in the presence of an end of life (EOL) condition.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system;

FIG. 2 is an electrical schematic of one exemplary non-limiting implementation of the present system;

FIG. 3 is an electrical schematic of another exemplary non-limiting implementation of the present system;

FIG. 4 is a flow chart showing overall non-limiting logic of the microprocessor;

FIG. 5 is a flow chart showing non-limiting logic for test operation and end of life operation; and

FIG. 6 is a flow chart showing non-limiting logic for reset operation.

### DETAILED DESCRIPTION OF THE PREFERRED EMBODIMENT

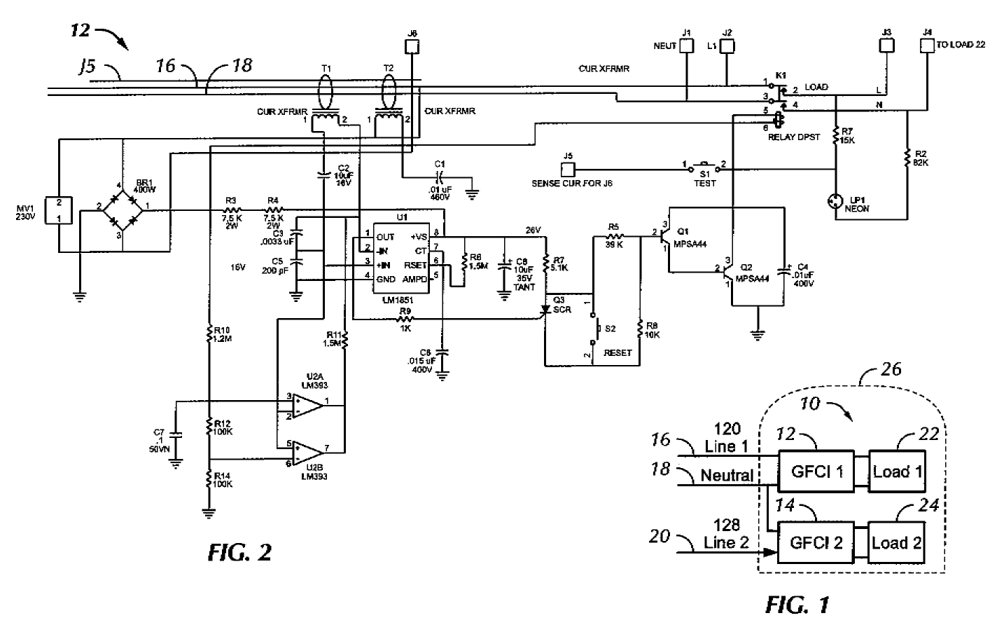

Referring initially to FIG. 1, a system is shown, generally designated 10, that includes a first GFCI device 12 in accordance with the present invention and a second GFCI device 14 that may be substantially identical to the first device 12 in configuration and operation. The first GFCI device 12 receives 120 volt power on a first power line 16 and also receives a neutral line 18. The second GFCI device 14 receives 120 volt power on a second power line 20 and is connected the neutral line 18, but apart from both GFCI devices receiving input from the same neutral line, neither GFCI device is connected to the other GFCI device and in particular none of the internal components such as the logic components of the GFCI devices are connected to components in the other GFCI device, such that the GFCI devices need not be and are not operated in multiples.

The first GFCI device 12 may have a socket for connecting to a first electrical load 22 while the second GFCI device 14 may have a socket for connecting to a second electrical load 24. Both GFCI devices 12, 14 may be located in a junction box 26, and with the arrangement shown the system 10 essentially is a 120/240 volt system. Additional power lines may be provided, with additional respective GFCI devices, or additional GFCI devices may be provided and associated with the same power lines.

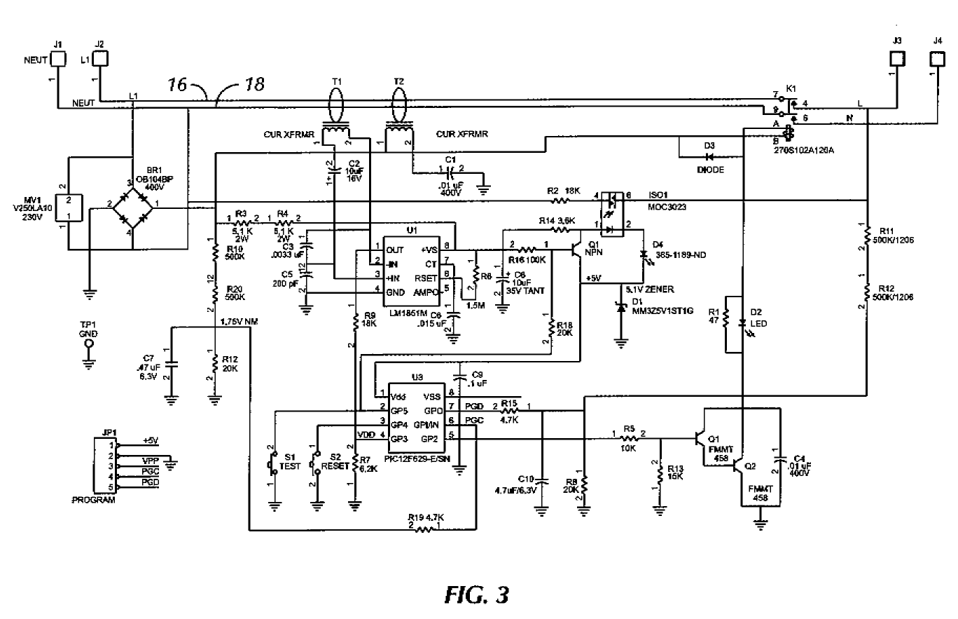

FIG. 2 shows a non-limiting implementation of the GFCI device 12. It is to be understood that the numerical values and component part numbers shown in the diagram are not limiting, and are provided for illustrating one non-limiting implementation.

Power is received as shown along the lines 16, 18 as previously described. The lines 16, 18 pass through the core of a toroidal current transformer T1, which is electrically connected to a logic component U1 which may be, without limitation, a type LM1851 component (non-programmable analog ground fault interrupter) made by National Semiconductor. In the embodiment shown, the logic component U1 as well as the below-described SCR Q1 and transistors Q2, Q3 receive rectified power from the lines 16, 18 through a bridge rectifier BR1, which is connected to the lines 16, 18, logic component U1, and additional components of the circuit as shown.

The transformer T1 may be, without limitation, a 1000-to-one step up transformer. When the current flowing through the power line 16 equals the current flowing through the neutral line 18 as it should under normal operating conditions, the transformer T1 does not send a signal to the logic component U1 to trip the circuit.

When a ground fault exists, however, the currents will not balance, causing a voltage to be generated by the transformer T1 which is interpreted by the logic component U1 to be a trip signal. Under these circumstances, the logic component U1 turns on a switch, such as the non-limiting silicon-controlled rectifier (SCR) Q3 to which the logic component U1 is connected as shown. In turn, in the non-limiting illustrative implementation shown the SCR Q3 deenergizes transistors Q1, Q2 to which the SCR is connected. These transistors normally (i.e., when no fault exists) are energized. The transistors Q1, Q2 in turn are connected to a relay K1 as shown, and when they are deenergized, the relay K1 is deenergized, opening associated contacts that are disposed as shown in the power line 16 and neutral line 18 between the power source, which taps into the power line 16 at input power terminal J2 and into the neutral line 18 at input neutral terminal J1, and load terminals J3, J4. As used herein, the term “relay” can refer to the relay coil proper and to the coil plus contacts that are actuated when the coil is energized and deenergized.

To test the operation of the relay K1, a manually operable test switch S1 is provided in a test line that extends between test terminals J5 and J6, it being understood that the terminals J5, J6 are connected together by a conductor passing through the transformer T1. When a person depresses the test switch S1, the logic component U1 senses a fault signal and causes the relay K1 to trip in accordance with the above disclosure. A reset switch S2 may be depressed to reset the circuit by deenergizing the SCR Q3.

Additional non-limiting features of the GFCI device 12 may include a power lamp LP1, which is illuminated when the relay K1 is not tripped to indicate the availability of power at the load terminals J3, J4. Also, a transient protection circuit MV1 may be provided in parallel with the bridge rectifier BR1 as shown for protecting the circuitry from power transients. Moreover, in non-limiting implementations a second transformer T2 can be provided through which the lines 16, 18 extend and which can be connected to the logic component U1 and relay K1 as shown for generating a trip current to the logic component U1 to cause it to trip the relay K1 in the event that the neutral line 18 is shorted to earth ground.

In accordance with the present invention, a comparator is provided to ensure proper GFCI functioning in a 120/240 volt arrangement in the event of either a broken neutral line 18 or a reversed power line 16/neutral line 18 error. With more specificity directed toward the preferred non-limiting embodiment shown in FIG. 2, two comparators U2A, U2B are provided in a window comparator configuration to send signals to the logic component U1. In the absence of over-voltages/under-voltage conditions, both comparators are “off”, i.e., their outputs to the logic component U1 are both high. However, when voltage falls below a low voltage threshold, one of the comparators outputs a low signal, which signals the logic component U1 to energize the SCR Q3 and open the circuit between the input terminals J1, J2 and load terminals J3, J4 in accordance with previous discussion. Similarly, when voltage exceeds a high voltage threshold, the other comparator outputs a low signal to signal the logic component U1 to open the circuit to the load terminals. The thresholds are established by the values of the resistors R10, R12, R14. The non-limiting values shown in FIG. 2 establish the high voltage threshold to be 156 volts and the low voltage threshold to be 78 volts.

It may now be appreciated that if the neutral line 18 is broken and the GFCI devices 12, 14 shown in FIG. 1 are essentially connected through a “virtual” neutral, the voltage between the power lines 16 of each device 12, 14 will be 240 volts. In the unlikely event that the loads are balanced, the GFCI devices operate normally in accordance with the above disclosure. However, should a load imbalance in the presence of a broken neutral cause an overvoltage or undervoltage condition, the window comparator will cause each device to trip, i.e., to open the circuit to its respective load. Likewise, if an overvoltage condition exists due to a power line 16 being connected to a neutral line terminal and vice-versa, the GFCI devices will trip on overvoltage. Furthermore, in accordance with present principles, the relay K1 of a GFCI device must have a minimum (“drop-out”) voltage at which it operates, and the operating voltage below which the GFCI circuit will not function is below the relay drop-out voltage, so that the relay drops out (and opens the circuit to the load) before the GFCI circuit stops functioning due to insufficient voltage from the bridge rectifier BR1.

While a window comparator is shown that uses an LM393 integrated circuit comparator, the term “comparator” as used herein also includes, e.g., a Zener diode with associated transistor that can generate a signal to trip the SCR without the need for the logic component U1. Further, while the preferred implementation envisions a window comparator, a single threshold implementation that uses only one of the comparators U2A, U2B is envisioned.

FIG. 3 shows an alternate non-limiting implementation of the GFCI device 12. It is to be understood that the numerical values and component part numbers shown in the diagram are not limiting, and are provided for illustrating one non-limiting implementation.

Power is received as shown along the lines 16, 18 as previously described. The lines 16, 18 pass through the core of a toroidal current transformer T1, which is electrically connected to a ground fault logic component U1 which may be, without limitation, a type LM1851 component made by National Semiconductor. In the embodiment shown, the ground fault logic component U1 as well as transistors Q1, Q2 receive rectified power from the lines 16, 18 through a bridge rectifier BR1, which is connected to the lines 16, 18, ground fault logic component U1, and additional components of the circuit as shown.

The transformer T1 may be, without limitation, a 1000-to-one step up transformer, When the current flowing through the power line 16 equals the current flowing through the neutral line 18 as it should under normal operating conditions, the transformer T1 does not send a signal to the ground fault logic component U1 to trip the circuit.

When a ground fault exists, however, the currents will not balance, causing a voltage to be generated by the transformer T1 which is interpreted by the ground fault logic component U1 to be a trip signal. Under these circumstances, the ground fault logic component U1 sends a signal to a programmable microcontroller U3, which may be implemented by an eight pin flash-based 8 bit CMOS microcontroller such as a type PIC12F629 microcontroller made by Microchip Technology, Inc. in non-limiting embodiments the logic component U3 includes a single onboard comparator and onboard non-volatile memory.

Upon the appropriate signal at pin 4 from the ground fault logic component U1, the microcontroller U3 causes the transistors Q1, Q2 to be deenergized. These transistors normally (i.e., when no fault exists) are energized. The transistors Q1, Q2 in turn are connected to the coil of a relay K1 as shown, and when they are deenergized, the relay K1 is deenergized, opening associated contacts that are disposed as shown in the power line 16 and neutral line 18 between the power source, which taps into the power line 16 at input power terminal J2 and into the neutral line 18 at input neutral terminal J1, and load terminals J3, J4.

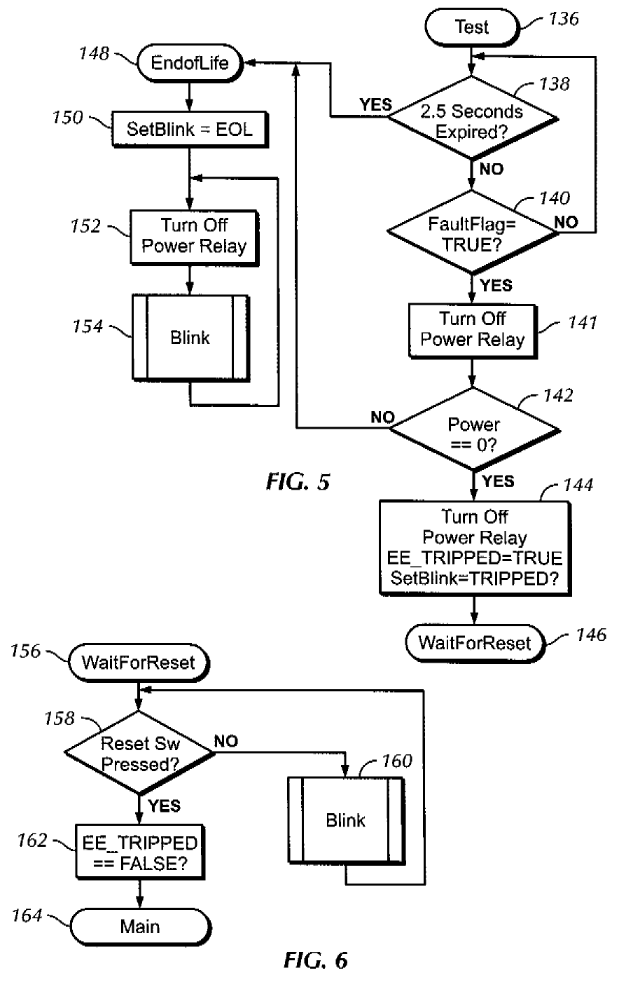

To test the operation of the relay K1, a manually operable test switch S1 is provided in a test line that extends from the microcontroller U3. When a person depresses the test switch S1, the microcontroller U3 functions as set forth below in reference to FIG. 5. A reset switch S2 is also connected to the microcontroller U3 and when it is manipulated the microcontroller U3 executes the logic of FIG. 6, discussed further below.

Additional non-limiting features of the GFCI device 12 may include a transient protection circuit MV1 which may be provided in parallel with the bridge rectifier BR1 as shown for protecting the circuitry from power transients. Moreover, in non-limiting implementations a second transformer T2 can be provided through which the lines 16, 18 extend and which can be connected to the ground fault logic component U1 and relay K1 as shown for generating a trip current to the ground fault logic component U1 to cause it to trip the relay K1 in the event that the neutral line 18 is shorted to earth ground.

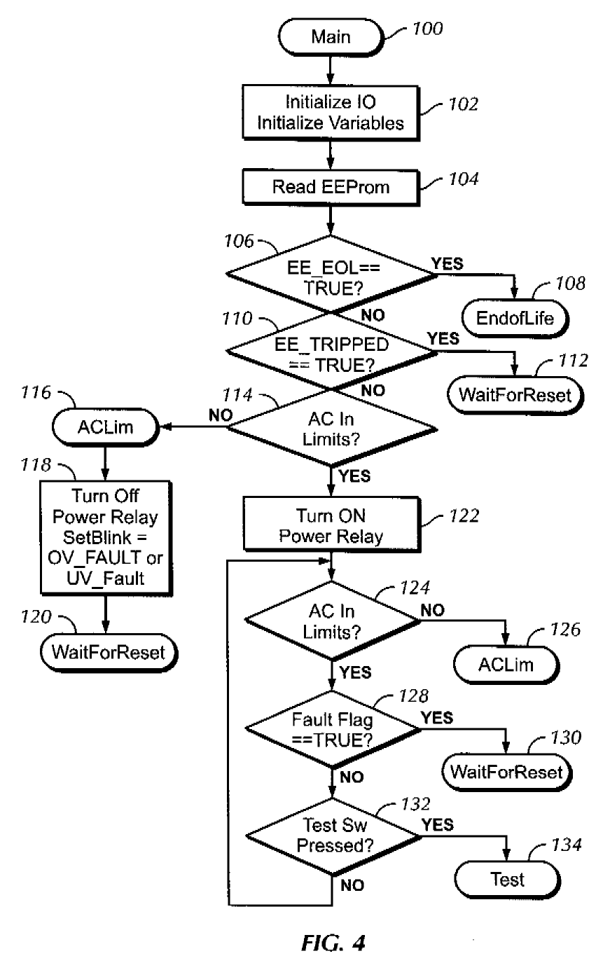

In accordance with the present invention, the microcontroller U3 ensures proper GFCI functioning in a 120/240 volt arrangement in the event of either a broken neutral line 18 or a reversed power line 16/neutral line 18 error, and it also provides for end-of-life (EOL) warnings and protection. With more specificity directed toward the preferred non-limiting embodiment shown in FIG. 3, pin 6 of the preferred non-limiting microcontroller U3 receives a signal from a voltage divider (including resistors R10, R20, and R12) off the bridge rectifier circuit BR1. This signal represents line voltage. The microcontroller U3 uses its onboard comparator to execute two sequential comparisons, namely, to compare the signal first to a low threshold (e.g., ninety volts) and then to a high threshold (e.g., one hundred thirty volts). If the signal is below the low threshold or above the high threshold, a broken neutral or miswired neutral/power line is indicated, and the logic component functions as set forth below in reference to FIG. 4.

To provide for EOL functionality as discussed further below in reference to FIG. 4, pin 1 of the ground fault logic component U1 is connected to pin 4 of the microcontroller U3. Also, pin 7 of the microcontroller U3 receives a voltage signal representative of relay K1 voltage through resistors R11 and R17 as shown.

A “power on” indication can be provided by a green LED D2, which is lit to indicate power is available through the GFCI, while a preferably red warning LED D4 can be provided to be energized by the logic component U3 as discussed more fully below. Additionally, an AC switch such as but not limited to an opto-isolator “ISO1” that is disposed between the bridge rectifier BR1 and load terminal J3 and between the transistor Q3 and LED D4 can be provided for purposes to be shortly disclosed. The opto-isolator may be a dual in-line type MOC3023 opto-isolator made by Lite-On Technology Corp.

Additional details of the circuit shown in Figure are as follows. The non-limiting microcontroller U3 requires a five volt power source. The ground fault logic component U1 provides a limited amount of current at approximately twenty six volts at its pin 8 from an internal Zener diode, and current from pin 8 is conducted through the resistor R2 and either the transistor Q3 or through the opto isolator and LED D4 to a five volt Zener diode D1, which maintains a five volt supply to pin 1 of the microcontroller U3.

The transistor Q3 is normally held on by a biasing resistor R16, thereby routing the current around the opto isolator and LED D4, When the TEST switch S1 is manipulated, the resistor R18 conducts the bias current away from the base of the transistor Q3, turning the transistor Q3 off and allowing current to flow through the opto isolator and the LED D4. This lights the LED D4 and turns on the triac output of the opto isolator, causing simulated fault current to be conducted through the resistor R2. This advantageously allows the LED D4 and optically isolated triac to be operated without drawing additional current.

In non-limiting implementation of the microcontroller U3, pins 1 and 8 are power supply pins, pin 2 is the TEST signal input and output, pin 3 is the RESET signal input, pin 4 is the input for a fault signal from the ground fault logic component U1, pin 5 provides ON/OFF control for the power relay K1, pin 6 is the line voltage input to the internal comparator of the microcontroller U3, and pin 7 is the output (load) voltage input pin.

Thus, in the non-limiting implementation shown pin 2 is used as both an input and output. As an input, the microcontroller U3 monitors pin 2 to see if the TEST switch has been manipulated. When the TEST switch is manipulated, pin 2 is made into an output, holding the switch point LOW. The TEST function therefore continues even if the switch S1 is only pressed momentarily. This is done because it may take up to two seconds for the simulated FAULT current to be detected. This arrangement also allows for periodic automatic testing by the microcontroller without manual operation of the TEST switch S1. The microcontroller also uses pin 2 as an output to light the FAULT indicator LED D4.

Now referring to FIG. 4, the main routine for the microcontroller U3 can be seen, which commences at state 100 and moves to state 102 upon power-on to initialize input/output ports and appropriate variables, e.g., the low and high voltage thresholds discussed above. The above-mentioned non-volatile memory (which may be an EEPROM) of the microcontroller U3 is read at state 104, and then a series of decisions is embarked on.

More particularly, the logic flows from state 104 to decision diamond 106 to determine whether an end of life flag (referred to in FIG. 4 is “EE_EOL”) that is read from the memory at state 104 is true. If so, the EOL routine discussed below in relation to FIG. 5 is entered at state 108.

If the EOL flag is not set, the logic flows from decision diamond 106 to decision diamond 110 to determine whether a relay tripped flag (“EE_TRIPPED”) read from memory is true, indicating that the relay K1 tripped on high current (ground fault). If so, the logic waits at state 112 for the reset logic of FIG. 6, entered when a person manipulates the reset switch S2. It is to be understood that when the relay K1 is tripped on overcurrent (ground fault) as indicated by the ground fault logic component U1 and received by the microcontroller U3, the EE_TRIPPED flag is set in non-volatile memory of the microcontroller U3 prior to losing all power.

If the relay K1 was not recorded in memory as being tripped, the logic flows from decision diamond 110 to decision diamond 114 to determine whether AC voltage is within limits. This test is the above-described sequential comparison to determine whether the signal representing line voltage as taken from the voltage divider off the bridge rectifier circuit is below a low threshold or above a high threshold. If voltage is not between the thresholds, the logic enters an AC limit logic at state 116, wherein at block 118 the microcontroller U3 deenergizes the relay K1 to open the circuit to the load and, if desired, to cause the LED D4 to blink to indicate an undervoltage or overvoltage fault and, hence, a broken neutral or reversed neutral/power lead. A reset signal is awaited at state 120.

When all three tests at decision diamonds 106, 110, and 114 are satisfactory on power-on, i.e., when EOL has not been reached, when the relay K1 is not recorded in memory as having tripped on high current (ground fault), and when no broken neutral or reversed neutral/power lead is detected, the logic turns on the relay K1 at block 122. Then, during operation with the relay K1 closed to supply power to the load terminals, the microcontroller U3 monitors for high/low AC voltage (broken neutral/miswired leads), ground fault tripping, and test operation, with this monitoring represented for ease of exposition by the decision diamonds 124, 128, 132 in FIG. 4 and associated action states 126, 130, 134.

More specifically, the microcontroller U3 determines at decision diamond 126 whether AC is in limits as discussed above and if not, enters the AC limit routine at state 126, in which the routine commencing at state 116 is performed. If a ground fault is detected at decision diamond 128 as indicated by the fault flag being set to true, the relay K1 is tripped and the reset routine of FIG. 6 discussed below is entered at state 130. If the test switch S1 is detected as having been manipulated at decision diamond 132, the test operation of FIG. 5 is entered at state 134. It is to be understood that if desired, the microcontroller U3 can periodically and automatically initiate the below-described test process itself without waiting for someone to manipulate the test switch S1.

Indeed and now referring to FIG. 5, when the test switch S1 is manipulated or periodically as automatically determined by the microcontroller U3, the test routine is entered at state 136, wherein the logic flows to decision diamond 138 to determine whether a predetermined period, e.g., two and a half seconds, has elapsed without both of the subsequent tests discussed below in relation to decision diamonds 140 and 142 having returned positive results.

When the test switch S1 is manipulated, the microcontroller U3 causes the opto-isolator to close, simulating a ground fault current through the transformer T1 which is detected by the ground fault logic component U1.

If the ground fault logic component U1 is functioning properly, owing to the closing of the opto-isolator the ground fault logic component U1 should send a fault signal from its pin 1 to pin 4 of the microcontroller U3 to so indicate, which in turn would set the fault flag in the microcontroller U3. This is tested for at decision diamond 140, and only if, within the time period of decision diamond 138, is the fault flag set to “true” does the logic move to block 141. Otherwise, from decision diamond 140 the EOL routine is entered at state 148 as shown.

Assuming the ground fault logic component U1 is functioning properly and the fault flag is set within the predetermined period after test initiation, the logic flows from decision diamond 140 to block 141. At block 141 the microcontroller U3 sends a signal through its pin 5 to the transistors Q1, Q2 to cause them to deenergize the power relay K1 at block 141. The logic continues to decision diamond 142, wherein it is determined whether voltage at the load terminal J3 is zero, as indicated by the signal through the resistors R11 and R17, input to pin 7 of the microcontroller U3, and latched in memory of the microcontroller U3 by the BE_TRIPPED flag. If the flag does not indicate tripped, i.e., if the relay K1 has failed to deenergize, the logic flows to EOL state 148. Otherwise, if both the ground fault logic component U1 and relay K1 function properly, the relay K1 is maintained off at state 144, the BE_TRIPPED flag stored in non-volatile memory of the microcontroller U3 is set to indicate this condition, and the LED D4 is caused to blink, visually indicating that a reset, waited for at state 146, must be undertaken by a person.

If, during the test, either the power relay K1 or ground fault logic component U1 fail to properly function as described above, the EOL routine at state 148 is entered to cause the logic to flow to block 150, wherein the microcontroller U3 may cause the LED D4 to blink to indicate EOL. The power relay K1 is deenergized at block 152 to open the circuit and further blinking in accordance with disclosure below may be undertaken at block 154. Note that no reset is possible once EOL has been reached, and since the EOL condition is set in non-volatile memory of the microcontroller U3, even if the system is completely deenergized and reenergized circuit operation will not permitted under an EOL condition.

Thus, the microcontroller U3 stores the end-of-life condition in memory that is maintained without power (non-volatile memory). Therefore, the end-of-life condition is maintained even if power is removed from the circuit and restored. When the power relay K1 is tripped due to a fault condition, that condition is also maintained in non-volatile memory. Therefore, if power is removed and restored, the circuit will be in the condition it was in before the loss of power, i.e., if the power relay K1 was tripped due to a fault before power was removed, it will still be tripped when power is restored, and if it was not tripped when power is removed, it will be in the power ON condition when power is restored.

As discussed above, two LED indicators (D2 and D4) provide a visual indication of the status of the circuit. The POWER ON indicator LED D2 is lighted whenever the power relay K1 is ON. Otherwise the LED D2 is OFF. In non-limiting implementations, the FAULT indicator LED D4 can be lighted continuously when a ground fault condition has been detected; when an end-of-life condition is detected it may continuously flash ON for one second and OFF for one second. And, if desired a low line voltage condition may be indicated by a continuously flashing rate of the LED D4 of ON for ½ second and OFF for ½ second, whereas a high line voltage condition may be indicated by a continuously flashing rate of ON for ⅕ second and OFF for ⅕ second. Other lighting heuristics may be used to help a person viewing the LED to distinguish which particular fault occurred.

When a ground fault condition, a low line voltage condition, or a high line voltage condition is indicated (or after a test), the RESET switch S2 may be manipulated to restore power. If the fault still exists, the circuit will return to the fault condition. As mentioned above, the end-of-life condition is permanent and will not be cleared by the RESET switch.

Accordingly and turning now to FIG. 6, as discussed above a reset operation may be awaited and this is indicated at state 156. When the reset switch S2 is detected at decision diamond 158 not to have been appropriately manipulated, the appropriate LED operation is continued at block 160. In contrast, when the reset switch S2 is detected at decision diamond 158 to have been appropriately manipulated, resetting the circuit and closing the relay K1 (assuming no continuing faults), the tripped flag is reset at block 162 and the main logic of FIG. 4 resumed at state 164.

While the particular GROUND FAULT CIRCUIT INTERRUPT DEVICE is herein shown and described in detail, it is to be understood that the subject matter which is encompassed by the present invention is limited only by the claims.

What is claimed is:

1. A GFCI device, comprising:
a current transformer engaged with at least one power line and a neutral line;
a ground fault logic component communicating with the current transformer for generating a signal to cause a circuit between an electrical load and a power supply connected to the power line to open based on a ground fault signal input from the transformer; and
at least one microcontroller communicating with the ground fault logic component and:
causing a circuit between the power supply and electrical load to open when at least one voltage in the device exceeds a maximum voltage threshold due to the neutral line being broken or due to a power line being connected to a neutral line terminal and vice-versa, and/or the microcontroller also causing the circuit between the power supply and electrical load to open when at least one voltage in the device falls below a minimum voltage threshold due to a neutral line being broken; and
causing a circuit between the power supply and electrical load to open when an end of life (EOL) condition is detected.

2. The GFCI device of claim 1, wherein the EOL condition is failure of a relay in the circuit to open in response to a test signal.

3. The GFCI device of claim 1, wherein the EOL condition is failure of the ground fault logic component to indicate a ground fault in response to a test signal.

4. The GFCI device of claim 1, wherein the EOL condition is failure of the ground fault logic component to indicate a ground fault in response to a test signal within a predetermined time period from initiation of the test signal.

5. The GFCI device of claim 1, wherein if an EOL condition exists, the GFCI cannot subsequently be reset to energize a load.

6. The GFCI device of claim 5, wherein an existence of an EOL condition is stored in non-volatile memory of the microcontroller.

7. The GFCI device of claim 1, wherein the EOL condition is detected during a test automatically initiated by the microcontroller.

8. A 120/240 volt junction box, comprising:
a first 120 volt line connected to a first GFCI device for powering at least a first load except under ground fault conditions, in which case the first GFCI device opens a circuit between the first 120 volt line and the first load;
a second 120 volt line connected to a second GFCI device for powering at least a second load except under ground fault conditions, in which case the second GFCI device opens a circuit between the second 120 volt line and the second load;
a neutral line connected to both devices;
first means in the first GFCI device for preventing malfunctioning of the first GFCI device in the presence of a ground fault if the neutral line is broken and for preventing malfunctioning of the first GFCI device in the presence of a ground fault if the neutral line is reversed with one of the 120 volt lines;
second means in the second GFCI device for preventing malfunctioning of the second GFCI device in the presence of a ground fault if the neutral line is broken and for preventing malfunctioning of the second GFCI device in the presence of a ground fault if the neutral line is reversed with one of the 120 volt lines;
third means in the first GFCI device for preventing operation of the first GFCI device in the presence of an end of life (EOL) condition; and
fourth means in the second GFCI device for preventing operation of the second GFCI device in the presence of an end of life (EOL) condition.

9. The junction box of claim 8, wherein the EOL condition is failure of a relay in the circuit to open in response to a test signal.

10. The junction box of claim 9, wherein the EOL condition is failure of the first means to indicate a ground fault in response to a test signal.

11. The junction box of claim 10, wherein the EOL condition is failure of the first means to indicate a ground fault in response to a test signal within a predetermined time period from initiation of the test signal.

12. The junction box of claim 8, wherein if an EOL condition exists in the first or second GFCI device, the GFCI device cannot subsequently be reset to energize a load.

13. The junction box of claim 8, wherein the first means includes a ground fault logic component providing detection of a ground fault and a microcontroller providing detection of high and low voltage and the EOL condition, an existence of an EOL condition being stored in non-volatile memory of the microcontroller.

14. The junction box of claim 13, wherein the EOL condition is detected during a test automatically initiated by the microcontroller.

15. A GFCI device, comprising:
a ground fault logic component outputting a signal representative of whether a ground fault exists; and
a microcontroller connected to the ground fault logic component and opening a circuit between the power line and a load when a ground fault exists, when a wiring fault exists, when an end of life (EOL) condition exists.

16. The GFCI device of claim 15, wherein the wiring fault exists when a neutral line is broken or a power line is connected to a neutral line terminal and vice-versa.

17. The GFCI device of claim 16, wherein the wiring fault exists when the neutral line is broken.

18. The GFCI device of claim 15, wherein the EOL condition is failure of a relay in the circuit to open in response to a test signal.

19. The GFCI device of claim 15, wherein the EOL condition is failure of the ground fault logic component to indicate a ground fault in response to a test signal.

20. The GFCI device of claim 15, wherein if an EOL condition exists, the GFCI cannot subsequently be reset to energize a load.
